(19) United States
(12) Patent Application Publication
(10) Pub. No.: US 2026/0088387 A1
(43) Pub. Date: Mar. 26, 2026

(54) Temperature Control Device

(71) Applicant: HYDAC Technology Corporation, Bethlehem, PA (US)

(72) Inventors: Ventress Colin Williams, Lincolnton (NC); Hugh Yuhua Dong, Apex (NC)

(73) Assignee: HYDAC Technology Corporation, Bethlehem, PA (US)

(21) Appl. No.: 19/325,001

(22) Filed: Sep. 10, 2025

(30) Foreign Application Priority Data
Sep. 23, 2024 (DE) 102024003068.9

(51) Int. Cl. H01M 10/63; B60L 58/26; B60L 58/27; F25B 25/00; F25B 43/00; H01M 10/613; H01M 10/625; H01M 10/6569

(52) U.S. Cl. CPC H01M 10/63; F25B 25/005; F25B 43/003; F25B 43/006; H01M 10/613; H01M 10/625; H01M 10/6569; B60L 58/26; B60L 58/27; H01M 2220/20

(57) ABSTRACT

The disclosure relates to a temperature control device, particularly for use in the e-mobility sector, at least consisting of a coolant circuit, in which a temperature controller for an electric battery is connected.

### CROSS-REFERENCE TO RELATED APPLICATIONS

This application claims priority to German Patent Application DE 10 2024 003 068.9, filed on Sep. 23, 2024 with the German Patent and Trademark Office. The contents of the aforesaid patent application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a temperature control device, in particular for use in the e-mobility sector.

EP 2 774 789 B1 discloses an industrial truck that is driven by electric batteries, having a heating device as a temperature control device, said heating device being furnished with a heat exchanger, wherein the industrial truck comprises a hydraulic circuit of an operating hydraulic system of the industrial truck, said system comprising a lifting cylinder that raises a load fork on a lift mast. The hydraulic circuit is used as the heat source for the heat exchanger, wherein said heat exchanger is heated with a heat pump, which uses the hydraulic circuit as the heat source via a hydraulic circuit heat exchanger, and wherein the heat exchanger is preferably used to heat the air in a driver's cab.

In addition to respectively heating or warming the air in a driver's cab, which, in electric battery-driven vehicles, needs to take place even with the electric motor switched off after long standing times, it is generally necessary to respectively control the temperature or cool the battery in such vehicles. In this context, independently of the thermal management system described above for heating the driver's cab, EP 2 930 782 B1 proposes an independent temperature control apparatus with a cooling element for cooling at least one component of a battery system, comprising an upper cooler part and a lower cooler part, wherein at least one cooling duct through which a cooling medium can flow is formed between the upper cooling part and the lower cooling part, wherein a Peltier element is arranged on the lower cooler part such that it lies laterally adjacent to and in some cases at the same level as the cooling duct. As such this ensures efficient cooling with minimal installation space for the temperature control apparatus, wherein, as a rule, there is already generally little available installation space in e-mobility vehicles due to the sheer size of the battery capacities used.

A need exists to provide an improved temperature control, for example for use in the e-mobility sector. The need is addressed by the subject matter of the independent claim(s). Embodiments of the invention are described in the dependent claims, the following description, and the drawings.

### BRIEF DESCRIPTION OF THE DRAWINGS

FIG. 1 takes the form of an example hydraulic circuit diagram showing the fluid flow in an example coolant circuit in conjunction with an example temperature control circuit for a battery;

FIGS. 2 and 3 show different perspective views of example components in the temperature control device according to FIG. 1.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, the temperature control device at least consists of a coolant circuit in which a temperature controller (also referred to herein as “temperature control apparatus”) for an electric battery is connected. Accordingly, battery temperature control, in particular cooling, may be manifestly connected to the air conditioning system that is generally already provided in a vehicle while using few components and thus saving installation space, which in practice is energy-efficient or energy-saving, respectively. Thus, in vehicles of any kind, including in aircraft and ships, air conditioning systems are currently of a technical standard to provide relief for operating staff in an increasingly warming (global) climate, which also benefits safety in the respective mode of transport.

In some embodiments of the temperature control device, it is provided that the coolant circuit comprises at least
two heat exchangers, one of which operates as a condenser, while the other operates as an evaporator, and
a compressor, plus
an expansion valve,
which may be connected to one another in a fluid-conveying manner by means of pipework/connections to conduct a coolant. In this manner, the temperature control device in its entirety can be obtained cost-effectively and/or with minimal technical outlay and/or minimal pipework, by using components of a vehicle air conditioning system that are already available.

In some embodiments of the temperature control device, it is provided that the temperature controller for the battery has a temperature control circuit, in particular a closed design of cooling circuit, the temperature control fluid in which flows from the battery through the heat exchanger acting as an evaporator and back to the battery, and a drivable fluid pump is used for this purpose. Due to the closed design of the cooling circuit, fluid losses may be avoided and energy-efficient circulation operation may be obtained for the temperature control fluid, particularly if the fluid pump can be driven by means of an electric motor connected to the battery. However, alternatively, it is also possible to configure the cooling circuit for the battery as an open circuit in which the temperature control fluid is then taken from a tank and returned back to this tank.

In some embodiments of the temperature control device, it is provided that, viewed in the fluid flow direction of the coolant, an accumulator (also referred to as an ‘accumulator apparatus’ herein) is connected behind one heat exchanger, which acts as a condenser and due to commercially available valve sizes, said accumulator being provided as a reservoir for coolant that enters the accumulator at at least one inlet, said accumulator having at least two outlets for coolant stored at least temporarily in the accumulator apparatus, which is in each case connected to an inlet point of an assigned expansion valve such as to conduct the coolant. In this manner, the cooling circuit is optimized such that, thanks to the accumulator and due to commercially available valve sizes, more cooling capacity is available for the battery than in known solutions in which the battery has an independent temperature controller separate from a coolant circuit. In particular, high-performance batteries, as used with their individual battery cells to drive electric vehicles, need to be maintained at a permanent preferred usage temperature of 20 to 30° C. by way of temperature control in order to ensure optimum performance, which is possible by using the aforementioned accumulator apparatus.

In some embodiments of the temperature control device, it is provided that the accumulator comprises an accumulator vessel in which both the inlet and the respective outlet are arranged on one free end face thereof, to which an immersion tube is connected in each case, said tube being guided in the direction of the bottom of the accumulator vessel. In this manner, the accumulator can be configured as a modular system due to the modularity of the accumulator housing, in particular with respect to its size, which provides a variety of possible applications for electric drive systems of many different kinds.

In some embodiments of the temperature control device, it is provided that the respective immersion tubes are connected to one another in a fluid-conveying manner in pairs at the bottom, forming a for example U-shaped curved tube, which, at its lowest point, has an extraction opening, for example furnished with a filter, for coolant from the accumulator vessel. In this manner, the immersion tube arrangement in the accumulator vessel creates a kind of fluid buffer, particularly for liquid, such that any temperature-related fluid shortages or surpluses can be compensated at any time, even as part of vapor formation.

For example, in this case it is also provided that a further inlet point of the respective expansion valve is connected in a fluid-conveying manner to a fluid discharge point of the evaporator, that an outlet point of the respective expansion valve is connected in a fluid-conveying manner to a collection apparatus, which is connected on its outlet side via a fluid-conveying line to the inlet side of the compressor, and that a further outlet point of the respective expansion valve is connected to an assigned supply point of the evaporator. In this manner, the various physical states of the fluid inside the cooling circuit with its components can accordingly be used effectively to control the temperature of the respective battery.

In some embodiments of the temperature control device, it is provided that a non-return valve is connected in the fluid line to the compressor, said non-return valve opening in the direction of the compressor. This thus prevents fluid, particularly in the gaseous state, being able to flow back from the compressor in the direction of the respective expansion valve in an undesirable manner, which could otherwise cause damage to the system as a whole.

For example, it is provided that tetrafluoropropene, R1234yf or R134a or blends of these coolants are used in a predefinable mixing ratio as coolants for the cooling circuit and demineralized water or a water-glycol mixture is used as a temperature control fluid, particularly in the form of the cooling fluid for the battery.

In some embodiments of the temperature control device, it is provided that the evaporator is formed by a plate heat exchanger, which ensures that the various fluid flows are separated in a media-tight manner, in particular the coolant circuit from the temperature control circuit or cooling circuit respectively for the battery are separated in a media-tight manner from one another.

The temperature control device is discussed in greater detail below with reference to further embodiments according to the FIGS.

The FIGS. are schematic and not necessarily to scale.

Specific references to components, process steps, and other elements are not intended to be limiting. Further, it is understood that like parts bear the same or similar reference numerals when referring to alternate FIGS.

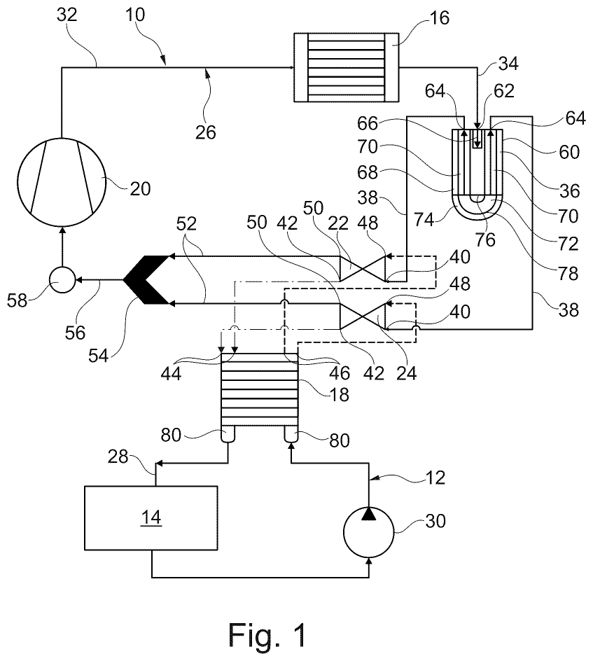

FIG. 1 is a hydraulic circuit diagram showing the temperature control device in its entirety as used in connection with manufacturing electric vehicles including aircraft and ships. The temperature control device comprises a coolant circuit referred to in its entirety as 10, in which a temperature control apparatus, referred to in its entirety as 12, for an electric battery 14 is connected. The battery 14 is for example made up of individual battery cells in the conventional manner, which is not therefore shown. The battery 14 is also shown by way of example as an individual battery; however, it is also conceivable that a plurality of corresponding or comparable batteries may also be supplied by the temperature controller 12.

The coolant circuit 10 shown in FIG. 1 comprises two heat exchangers, one of which operates as a condenser 16, while the other operates as an evaporator 18. Furthermore, a compressor 20 is available to circulate the coolant in the coolant circuit 10, although if necessary said compressor may also be replaced by a different suitable fluid-conveying apparatus that compresses the fluid flow. Furthermore, two expansion valves 22, 24 of the conventional design are used inside the coolant circuit 10, said valves each having two fluid inlet points 40, 48 and two fluid outlet points 42, 50, as explained in further detail below. Furthermore, all components of the coolant circuit 10 are connected to one another via conventional pipework 26 by using individual pipe sections to conduct the respective coolant in a fluid-conveying manner. All aforementioned components of the coolant circuit 10 are commercially available and can be purchased readily. A heat exchanger as disclosed in DE 10 2010 046 913 A1 or U.S. Pat. No. 4,934,455 can be used as an evaporator 18. Other suitable plate heat exchangers may be used.

The temperature controller 12 for the battery 14 comprises an independent temperature control circuit 28, in particular in the form of a closed cooling circuit, the temperature control fluid in which flows from the battery 14 through the heat exchanger acting as an evaporator 18 and back to the battery 14, for which purpose a conventional drivable fluid pump 30 is used, which can be driven by an electric motor of the vehicle. However, an open circuit can also be selected instead of a closed circuit, in which case the temperature control fluid for the battery 14 is taken from a tank (not shown) and returned back there. As it flows through the evaporator 18, the temperature control fluid in the temperature control circuit 28 is cooled on a regular basis, for example to a temperature of 20 to 30° C.; this temperature range provides a uniform high performance level for the battery 14. If the battery 14 experiences very low temperatures, for example when starting in winter, the temperature control fluid in the temperature control circuit 28, which passes through the evaporator 18, can also be used to warm up the battery 14 in the corresponding case if necessary.

The coolant, which is usually liquid, is converted to the gaseous state in the evaporator 18, the coolant taking a certain amount of heat from the battery circuit for air conditioning purposes in this process, as required for evaporation. The temperature then falls as a result. In contrast, the purpose of the compressor 20 or condenser respectively is to increase the pressure and thus the temperature of the gaseous coolant. It is also responsible, as explained above, for circulation of the coolant in the coolant circuit 10 and, in this process, raises the energy level such that the absorbed energy can be discharged to the outside via the condenser 16 that is next in line in the circuit. Corresponding compressors 20 or condensers are generally driven by motors, in this case in the form of an electric motor of the vehicle.

In turn, the condenser 16 functions as a cooler, acting as a conventional heat exchanger, and the air flowing through the heat exchanger, usually in the form of motion air, absorbs heat such that the ‘hot’ coolant gas can be cooled down and condensed accordingly. During circulation, the aforementioned coolant in the coolant circuit 10 therefore constantly changes its respective physical state from gaseous to liquid and back again. In this process, the aforementioned expansion valves 22, 24 measure the quantity of coolant gas that passes into the evaporator 18 so that the cooling performance can be adjusted to each operating state of the vehicle in this manner.

High pressure generally prevails in the corresponding connection line 32 between the outlet side of the compressor 20 and the inlet side of the condenser 16 and the coolant is gaseous when the pressure is 16 bar, for example, and at a temperature of 65° C.

High pressure also prevails on the outlet side of the condenser 16 in the further connection line 34, the respective coolant used now being liquid at a pressure of, say, 16 bar and a temperature of 55° C. By interposing an accumulator 36, which will be explained in further detail below, the coolant then passes from the outlet side of the accumulator 36 via additional connection lines 38 to an inlet point 40 of the respective expansion valve 22, 24, which takes place at the aforementioned high pressure of approximately 16 bar in the liquid physical state.

Viewed in the fluid direction after the respective expansion valve 22, 24, at a corresponding outlet point 42, the coolant is passed on to the two supply points 44 in the evaporator 18 at low pressure and in the liquid physical state at, for example, 1.2 bar and −7° C. The coolant supplied via the supply points 44 flows through the corresponding ducts in the plate heat exchanger acting as an evaporator 18 and reaches a further inlet point 48 on the respective assigned expansion valve 22, 24 on the outlet side via the two discharge points 46 on the evaporator 18. At the corresponding respective inlet point 48, the coolant is then under low pressure and is in the gaseous physical state with a pressure, by way of example, of 1.2 bar and a temperature of approximately −3° C.

After passing through the respective expansion valve 22, 24, the coolant passes in the low pressure range via its outlet points 50 and adjoining connection pipes 52 to a collection apparatus 54 on the inlet side, which connects the two fluid flows on the outlet side of the two expansion valves 22, 24 in the form of a switch or T-piece and to the inlet side of the compressor 20 via an adjoining connection pipe or line 56. A non-return valve 58 (not shown) is connected in the connection pipe 56 in the conventional manner, said valve opening in the direction of the compressor 20 and preventing an undesirable backflow of coolant from the compressor 20 to the collection apparatus 54, particularly when the temperature control device is in the disconnected state. The aforementioned pressure and temperature control values are only given by way of example and are intended to provide a more detailed explanation of the conditions for the coolant in the corresponding circuit.

The compressor 20, which thus once again receives coolant at a low pressure, for example at a pressure of approximately 1.2 bar, from the collection apparatus 54, then in turn compresses the accordingly gaseous coolant, which becomes ‘hot’ again as a result. The condenser 16 then cools the hot gaseous coolant until it condenses and becomes liquid. After the respective expansion valve 22, 24, the coolant then in turn expands, becoming gaseous in this process, and passes on its cold properties to the evaporator 18, which cools the temperature control circuit 28 with these cold temperatures and thus also the battery 14 with its individual battery cells.

As mentioned above, the coolant circuit 10 according to FIG. 1 comprises an accumulator 36 with an accumulator vessel 60, for example in the form of a bowl, both an inlet 62 and two outlets 64 for supplying or discharging coolant being arranged on one upper free end face thereof. An inlet nozzle 66 adjoins the inlet 62, said nozzle protruding from the upper end face of the accumulator vessel 60 into the interior 68 thereof, starting from a free section. A hollow immersion tube 70 with the same design is connected to the respective outlet 64, said immersion tube assuming an identical axial installation length in the accumulator vessel 60. The immersion tubes 70 with the same installation length are connected to one another in a fluid-conveying manner at the bottom via a U-shaped curved tube 72. On the opposite side, the two immersion tubes 70 each open into the assignable additional connecting pipe 38 to the expansion valves 22, 24. A kind of reservoir 74 is formed as a result along the bottom side of the accumulator vessel 60 to receive a predefinable quantity of coolant. The filling line 76 and thus the volume of the reservoir 74 inside the accumulator vessel 60 change according to the filling level. At the lowest point of the U-shaped curved tube 72, there is an extraction opening 78 (not shown) for coolant from the reservoir 74, wherein the corresponding extraction opening 78 may have a filter (not shown), for example in the form of a particulate filter. By virtue of the fact that coolant can be extracted from the accumulator vessel 60 of the accumulator 36 simultaneously, with a pair of immersion tubes 70, a larger, in particular twice the amount of coolant fluid can be discharged via the expansion valves 22, 24 into the evaporator 18, which increases the temperature control or cooling performance of the temperature controller 12 of the battery temperature control circuit 28 and thus improves cooling for the battery 14. According to the teachings herein, a plurality of immersion tube pairs may also be provided inside an accumulator 36, as explained, or a plurality of such accumulators 36 with pairs of immersion tubes 70 may be provided as part of a coolant circuit 10, although they do not necessarily have to be connected via a curved tube 72. Finally, however, the U-shaped curved tube 72 with a central extraction opening 78 in the bottom allows a uniform volume distribution of the coolant stored in the reservoir 74 to both immersion tubes 70 simultaneously such that both expansion valves 22, 24 are supplied equally with the coolant to be passed on to the evaporator 18. The two immersion tubes 70 with the tube part 72 can also be created by bending a single continuous tube of suitable length so as to form a U-shape.

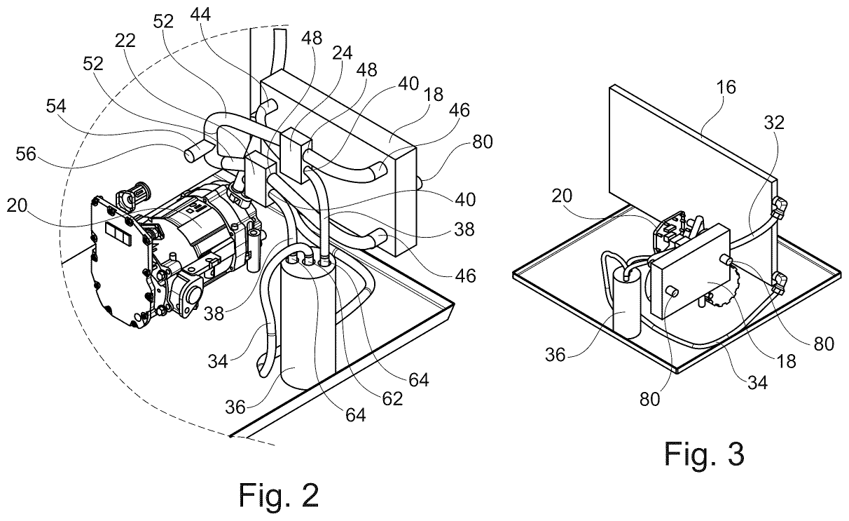

FIGS. 2 and 3 then show the spatial arrangement of the individual components of the temperature control device according to FIG. 1, which demonstrate that a particularly space-saving structure is possible. Moreover, FIGS. 2 and 3 show the cylindrical structure of the accumulator vessel 60 of the accumulator 36 and the plate-shaped structure of the two heat exchangers 16 and 18. The temperature control circuit 28 connected to the evaporator 18 with the battery 14 and the fluid pump 30 along with the associated pipework is only shown in FIGS. 2 and 3 up to the two connection points 80 with which the battery temperature control circuit 28 is connected on the supply and discharge sides to the evaporator 18 in the form of a plate heat exchanger. Otherwise, the previous descriptions of the coolant circuit 10 and the temperature controller 12 also apply to the perspective product drawings according to FIGS. 2 and 3. Accordingly, the same reference numerals are also used for the same components and the descriptions provided for these also apply to the embodiments shown in FIGS. 2 and 3.

In any event, the temperature control device according to the teachings herein achieves an increase in cooling performance when cooling a battery 14 in the e-mobility sector with vehicles of any kind, wherein even cooling circuits 10 that are already present in vehicles can be completely modified and used with the accumulator 36. It should be pointed out at this juncture that the collection apparatus 54 can also perform a drying function and may also serve as a compensation and/or storage container.

For example, a blend of 50% R1234yf and 50% R134a is provided as coolant for the coolant circuit 10. A water-glycol mixture is for example used as a temperature control fluid or cooling fluid respectively for the battery 14.

The invention has been described in the preceding using various example embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The terms “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1. A temperature control device, at least comprising a coolant circuit, in which a temperature controller for an electric battery is connected.

2. The temperature control device of claim 1, wherein the coolant circuit comprises at least:
two heat exchangers, one of which operates as a condenser, while the other operates as an evaporator; and
a compressor; and
an expansion valve; which are connected to one another in a fluid-conveying manner by means of pipework to conduct a coolant.

3. The temperature control device of claim 1, wherein the temperature controller for the battery has a temperature control circuit, the temperature control fluid in which flows from the battery through the heat exchanger acting as an evaporator and back to the battery and a drivable fluid pump is used for this purpose.

4. The temperature control device of claim 1, wherein, viewed in the fluid flow direction of the coolant, an accumulator is connected behind one heat exchanger, which acts as a condenser, said accumulator being provided as a reservoir for coolant that enters the accumulator at at least one inlet, said accumulator having at least two outlets for coolant stored at least temporarily in the accumulator, which is in each case connected to an inlet point of an assigned expansion valve such as to conduct the coolant.

5. The temperature control device of claim 4, wherein the accumulator comprises an accumulator vessel, in which both the inlet and the respective outlet are arranged on one free end face thereof, to which an immersion tube is connected in each case, said tube being guided in the direction of the bottom of the accumulator vessel.

6. The temperature control device of claim 5, wherein the respective immersion tubes are connected to one another in a fluid-conveying manner in pairs at the bottom, which, at its lowest point, has an extraction opening, for coolant from the accumulator vessel.

7. The temperature control device of claim 2, wherein a further inlet point of the respective expansion valve is connected in a fluid-conveying manner to a fluid discharge point of the evaporator, wherein an outlet point of the respective expansion valve is connected in a fluid-conveying manner to a collection apparatus, which is connected on its outlet side via a fluid-conveying line to the inlet side of the compressor, and wherein a further outlet point of the respective expansion valve is connected to a supply point of the evaporator.

8. The temperature control device of claim 2, wherein a non-return valve is connected in the fluid line to the compressor, said non-return valve opening in the direction of the compressor.

9. The temperature control device of claim 1, wherein tetrafluoropropene, R1234yf or R134a or blends of these coolants in a predefinable mixing ratio are used as coolants for the cooling circuit and demineralized water or a water-glycol mixture is used as a temperature control fluid, particularly in the form of the cooling fluid for the battery.

10. The temperature control device of claim 2, wherein the evaporator is formed by a plate heat exchanger.

11. The temperature control device of claim 1, configured for use in an e-mobility application or in an electric vehicle.

12. The temperature control device of claim 1, wherein the temperature controller for the battery has a temperature control circuit with a closed design, the temperature control fluid in which flows from the battery through the heat exchanger acting as an evaporator and back to the battery and a drivable fluid pump is used for this purpose.

13. The temperature control device of claim 2, wherein the temperature controller for the battery has a temperature control circuit, the temperature control fluid in which flows from the battery through the heat exchanger acting as an evaporator and back to the battery and a drivable fluid pump is used for this purpose.

14. The temperature control device of claim 2, wherein, viewed in the fluid flow direction of the coolant, an accumulator is connected behind one heat exchanger, which acts as a condenser, said accumulator being provided as a reservoir for coolant that enters the accumulator at at least one inlet, said accumulator having at least two outlets for coolant stored at least temporarily in the accumulator, which is in each case connected to an inlet point of an assigned expansion valve such as to conduct the coolant.

15. The temperature control device of claim 3, wherein, viewed in the fluid flow direction of the coolant, an accumulator is connected behind one heat exchanger, which acts as a condenser, said accumulator being provided as a reservoir for coolant that enters the accumulator at at least one inlet, said accumulator having at least two outlets for coolant stored at least temporarily in the accumulator, which is in each case connected to an inlet point of an assigned expansion valve such as to conduct the coolant.

16. The temperature control device of claim 5, wherein the respective immersion tubes are connected to one another in a fluid-conveying manner in pairs at the bottom, forming a U-shaped curved tube, which, at its lowest point, has an extraction opening for coolant from the accumulator vessel.

17. The temperature control device of claim 5, wherein the respective immersion tubes are connected to one another in a fluid-conveying manner in pairs at the bottom, which, at its lowest point, has an extraction opening furnished with a filter for coolant from the accumulator vessel.
